(19) United States
(12) Patent Application Publication
(10) Pub. No.: US 2010/0247223 A1
(43) Pub. Date: Sep. 30, 2010

(54) STYLUS-SUBSTRATE SYSTEM FOR DIRECT IMAGING, DRAWING, AND RECORDING

(76) Inventor: Hans O. Ribi, Hillsborough, CA (US)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 12/517,894

(22) PCT Filed: Dec. 21, 2007
(86) PCT No.: PCT/US07/26209

§ 371 Date: May 20, 2010

Related U.S. Application Data
(60) Provisional application No. 60/876,776, filed on Dec. 22, 2006.

(51) Int. Cl. B43K 29/00; B43K 1/10

(52) U.S. Cl. 401/195; 401/258

(57) ABSTRACT

Stylus-substrate system components include an optical transitioning or color changing substrate and a stylus device/mechanism for inducing the optical transition or color change in the substrate. The optical transitioning or color change substrate possess all of the chemical components necessary to generate a single color or multiple color image, written matter, graphics, markings or recorded information. The stylus device/mechanism possesses the physical, electrical, and/or mechanical means for inducing the single or multi-colored change in the substrate.

### CROSS-REFERENCE TO RELATED APPLICATIONS

Pursuant to 35 U.S.C. §119 (e), this application claims priority to the filing date of: U.S. Provisional Patent Application Ser. No. 60/876,776 filed Dec. 22, 2006, the disclosure of which application is herein incorporated by reference.

### INTRODUCTION

Several color change technologies have previously been applied to drawing, craft, and art projects. Typically, color change or color appearance methods involve scratching off a pigment coating that obscures a colored pattern (e.g. Scratch Art™). Other products utilize leuco dye systems where one dye component is printed on a substrate and a second component is delivered by a solvent means from a marking pen to develop a color on the substrate (e.g Color Wonder and Color Explosion™). In these examples, either vigorous rubbing and paint removal are required, or chemical handling and transfer are required. New color development systems are of on-going and strong interest to the toy, drawing, printing, craft, art, security, advertising, novelty, package and printing industries.

A range of new product opportunities, industry applications, and product categories could be created or benefit from a simple to use stylus substrate system that did not require chemical transfer, rubbing off of a masking dye layer, or complications of use. Furthermore, unique user-interfaces, designs, patterning effects, color-change effects, optical effects, visual effects, and the like can be made possible the interactive stylus-substrate system disclosed here in.

### SUMMARY

Stylus-substrate system components include an optical transitioning or color changing substrate and a stylus device/mechanism for inducing the optical transition or color change in the substrate. The optical transitioning or color change substrate possess all of the chemical components necessary to generate a single color or multiple color image, written matter, graphics, markings or recorded information. The stylus device/mechanism possesses the physical, electrical, and/or mechanical means for inducing the single or multi-colored change in the substrate.

Multiple triggering element intrinsic color change substrates can be made to change color using various physical, electrical, or chemical induction processes including, but not limited to friction, sheer, heat, pressure, sonic disruption, combinations of friction and heat, sheer and heat, pressure and friction, pressure hand heat, sonic disruption and pressure, liquid/chemical, sonic disruption, and heat or other triggering mechanism permutations alone or in combination.

### BRIEF DESCRIPTION OF THE FIGURES

FIGS. 1 to 8 provide representations of different stylus/color change activation types and substrates, as well as examples of different products that can be made with the subject inventive system.

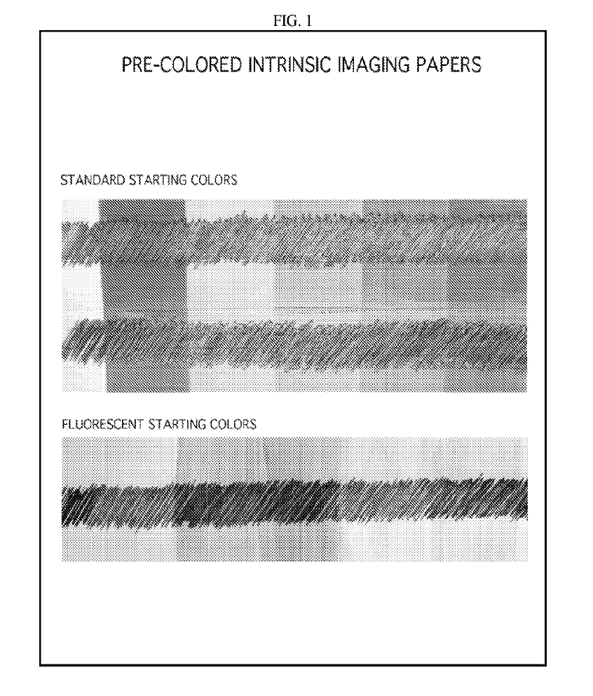

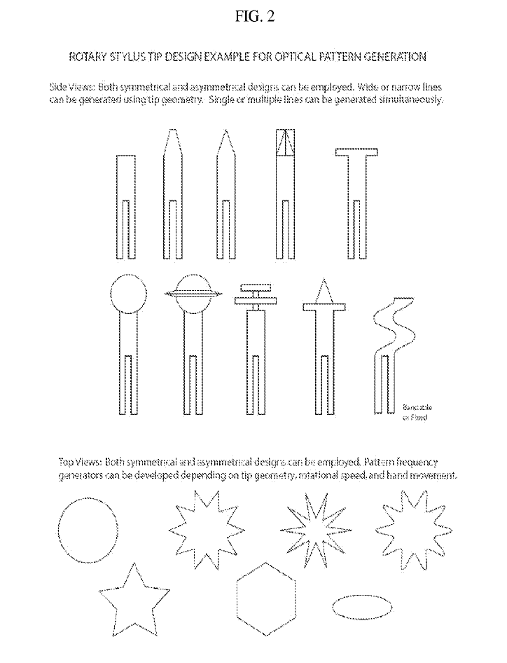

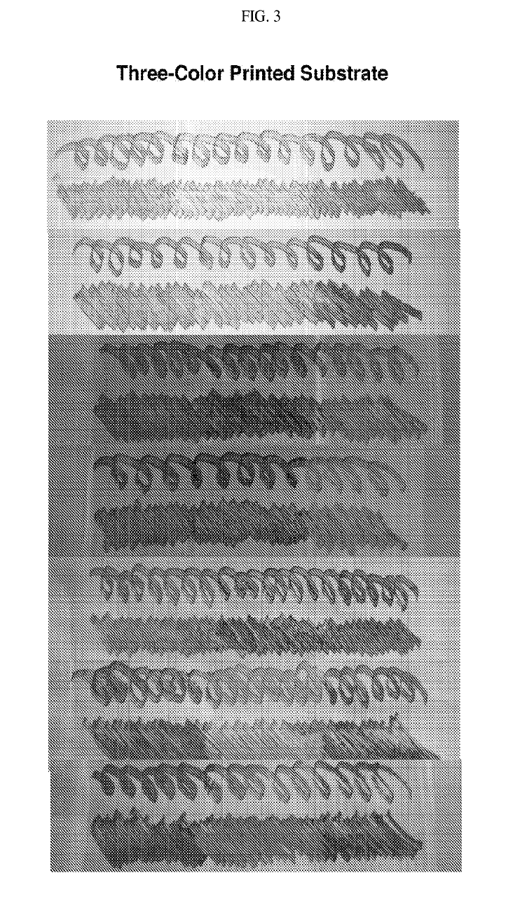

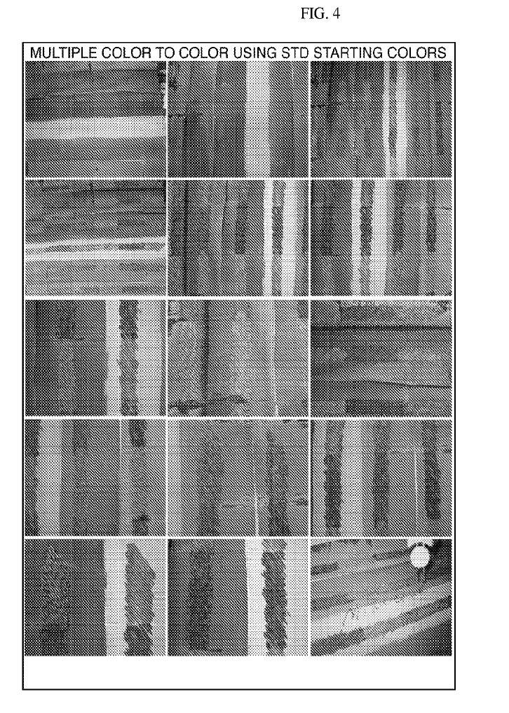

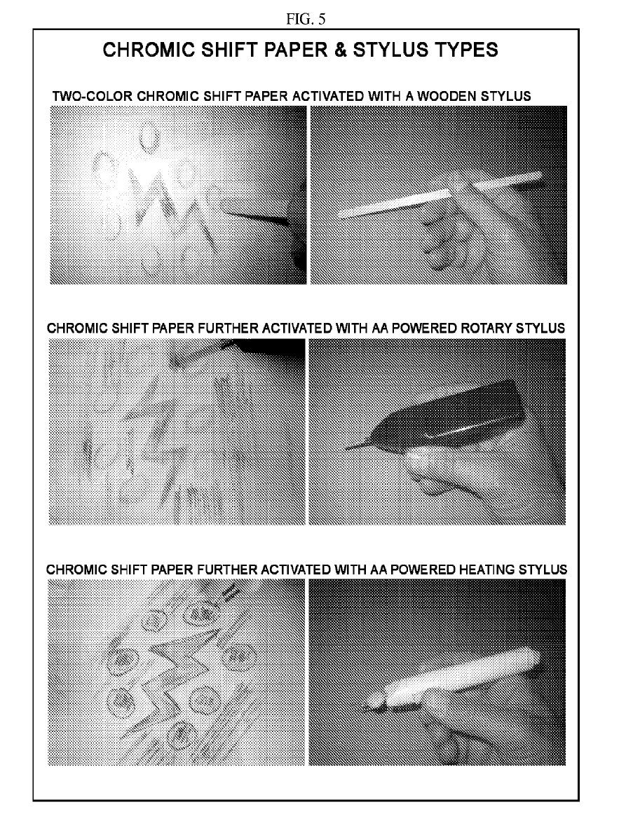

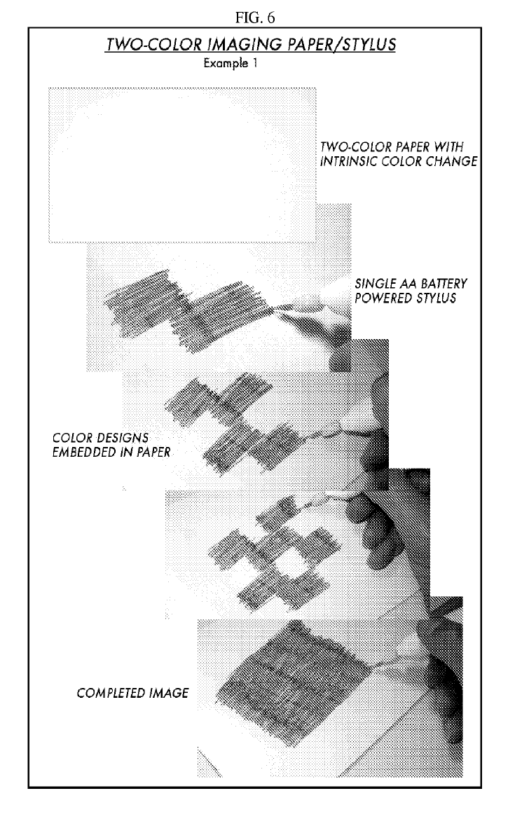

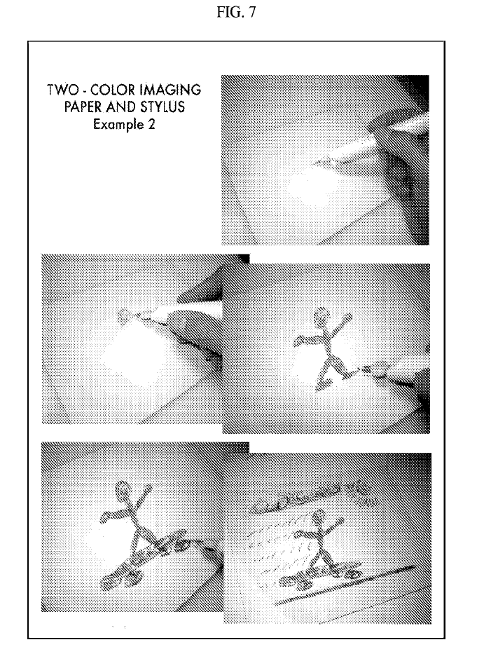

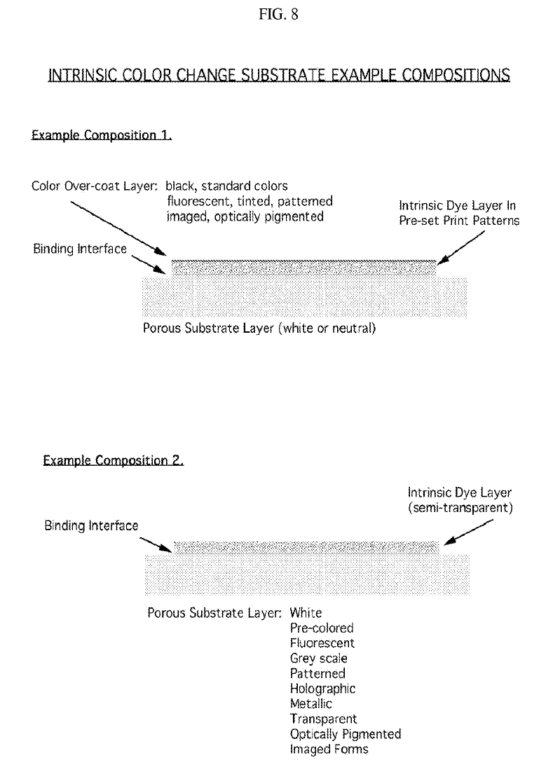

### DETAILED DESCRIPTION

As reviewed above, stylus-substrate system components include an optical transitioning or color changing substrate and a stylus device/mechanism for inducing the optical transition or color change in the substrate. The optical transitioning or color change substrate possess all of the chemical components necessary to generate a single color or multiple color image, written matter, graphics, markings or recorded information. The stylus device/mechanism possesses the physical, electrical, and/or mechanical means for inducing the single or multi-colored change in the substrate.

Multiple triggering element intrinsic color change substrates can be made to change color using various physical, electrical, or chemical induction processes including, but not limited to friction, sheer, heat, pressure, sonic disruption, combinations of friction and heat, sheer and heat, pressure and friction, pressure hand heat, sonic disruption and pressure, sonic disruption and heat or other triggering mechanism permutations.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### Rotary Stylus System Types:

Rotational mechanisms can be direct drive or utilize gears and gear ratios. Often it will be desirable to use low cost high torque servo-motors and standard DC or AC magnetic drive motors. Direct drive motor mechanism can be used for simplistic motor drive product applications. Direct drive mechanisms can include, but are not limited to directly attaching the stylus tip to the end of a motor axel. Alternatively, belts or gear drives can be attached to maintain an equivalent rotational ratio or increase or decrease the speed of the tip according to the requirements of the application of interest. Further alternatives include air turbine driven rotary mechanisms including those similar to dentist's drills and the like.

Likewise, rotary stylus tips can be driven using stepper motors and stepper motor control systems. Stepper motor systems have the advantage of utilizing high resolution digital encoding for precise and programmable motor function. Motor drives can be more readily interfaced with computer systems, programmable CPU's, personnel computers and the like.

Rotary stylus tips for direct recording on frictional/heat sensitive substrates can range in rotation speeds from less than 100 rpm to over 80,000 rpm. More usually, tip rotational rates will range between 1000 rpm to 60,000 rpm. Typically useful rotational rates will be between 5,000 rpm and 40,000 rpm. Most often, rotational rates will be between 10,000 rpm and 30,000 rpm.

Continuous or pulsed mechanisms for tip rotation can be applied. Pulsed mechanisms can be used for pattern generation, patterning processing, increased play value, visual effects and various uses for encoding or recording a chromic change in the intrinsic chromic change substrate. Combinations of rotary stylus tip and heating element tip mechanisms can be used in combination where a rotary stylus tip also employs a heating element to create dual effect tip.

### Rotary Stylus Tip Types and Pattern Generators:

Pattern generation can be accomplished by utilizing stylus tips with different designs. A particular tip design can be fabricated such that patterns or lines can be generated in an intrinsic substrate as the tip is rotating at a particular speed and/or drawn over the substrate with a particular motion. Line types and patterns can include, but are not limited to: various line widths, line crispness, line shapes, line fading, brush stroke shapes, dashed patterns, spiral shaped, spatter stroked, discontinuous line segments, pre-programmed and intermittent lines, scattered line shaped, entangled shapes, and the like.

Rotary stylus tip types and shapes can include, but are not limited to: pin points for fine lines, rounded ended shapes, sharp pointed ends, beveled ends, disc shapes, ball shapes, geometrically shaped ends, chisel shaped ends, flat edged ends, pin-point tip ends, sharp or blunt shapes, cross shaped ends, single or multiple prong shaped ends, conical, barrel shaped, puckered, threaded shapes, spiral ended, screw shaped, bolt shaped, ridged ended, symmetrical gear shaped, asymmetrical gear shaped, round, oval, square, diamond, pentagonal, hexagonal, heptagonal, octagonal and related shaped, open and closed type, perforated types, frosted or smooth ended, tube types and shapes, brush shapes including long and short bristled brushes, and the like.

Any of a wide range of hard, pliable, elastic, or other materials can be effectively utilized in making rotary stylus tips. Materials that can include, but are not limited to: plastics, wood, fabrics, metals, anodized metals, glass, polymer composites, shape memory materials, shape memory alloys, ceramic and porcelain, polymer surfaces, paint coated, powder coated metals, paper, printed paper, rubber, concreted and plaster, stone, surfaces printed with ink, plastic laminate coatings, glass, vinyl types, plaster, and a wide range of other common or technical materials.

Frictionally sensitive or insensitive materials can be employed for different tip effects. Hard, smooth, and slippery plastic stylus tips including Teflon™ or the like have the advantage of reduced adhesion and attachment of an ink layer to the stylus tip during high or low rotation speeds and contact. Smooth hard plastics have the further advantage of improving handling and ease-of-use by allowing the tip to glide over a substrate surface during use. Likewise, sharp tips can be used for high definition writing and detailed drawing whereas wide blunt tips can be used to create broad heavier lines during drawing or recording.

Plastic/composition types for stylus tips can include, but are not limited to: polyvinyl chloride (PVC), various polyolefins such as polypropylene and polyethylene, high density polyethylene (HDPE), low density polyethylene (LDPE), cross-linked high-density polyethylene (XLPE), softened acrylic, ABS, thick Kapton™ tape materials, Teflon® (polytetrafluoroethylene (PTFE), tetrafluoroethylene TFE and fluorinated ethylene polyproplyene FEP)-based materials, brand names such as Kydex, polystyrene, thermoplastic polyesters, nylon, pencil eraser rubber, styrene-butadiene, epoxy casts, polybutylene, TPX (poly(methyl pentene), terephtalate polyethylene (PET), PETE, PETF, polyethylene teraphthalate G copolymer (PETG), polysulfone (PSF), polyutethane (PUR) Thermanox™ (TMX), polymethylmethacrylate, and the like. Strong flexible plastics such as polycarbonate are often desirable. Polycarbonate can be thermoformed, pressure formed, and injection molded.

Other exemplary plastics may include, but are not limited to: ethylenechlorotrifluoreethylene (ECTFE), ethylentetrafluorethylene (ETFE), polinvinylidene fluoride (PVDF), ethylene-propylene rubber (EPR), silicone rubber (SI), Alcryn® thermoplastic rubber (TPR), HT thermoplastic rubber (HTPR), Santoprene® thermoplastic rubber (TPR), LSOH crosslinked compounds, LSOH thermoplastic compounds, methylvinyletherfluoralkoxy (MFA), perfluoroalkoxy (PFA), thermoplastic polyester elastomer (TPE), polyimide (Kapton®), polyurethane (PUR), polyvinyl chloride 105° C. (PVC), polyvinyl chloride 70° C. (PVC), low temperature polyvinyl chloride (LTPVC), oil resistant Polyvinyl chloride (OR PVC), semirigid polyvinyl (SR PVC), polyvinyl chloride polyurethane (PVC PUR), silicon rubber, ethyl vinyl acetates, and the like.

Stylus tip types can be molded, injection molded machined, compression molded, two component epoxy molded, cast, die-cut, milled, thermoformed, extruded, co-extruded, coated, powder coated, dip coated, punched, die cut, turned, made by CNC mills, made by lamination, draw from a melt, glued, vacuum formed, and the like. Method for making and producing a frictional stylus tip will be determined by the application of interest, ease of use, functionality, cost, and related specifications.

### Thermoelectric Stylus Systems:

Thermoelectric heating and cooling elements can be utilized such that a stylus tip can be utilized as a heating element or cooling element. Dye systems can be utilized that change color upon heating or cooling. Thermoelectric devices can possess the ability to either initiate a color change upon cooling on the cooling side of a device or initiate a color change upon heating on the heating side of a device. Pivoting mechanisms can be employed whereby miniature stylus tips can be pivoted or rotated so that tip can be adjusted for either cooling or heating applications. A wide range of thermoelectric or Peltier heating and cooling devices can be purchased from commercially available electronic component supply manufactures.

### Vibration Frictional Stylus Systems:

Vibrating forces induced in a stylus type can impact localized pressures and frictional forces on a dye layer. Vibrating frictional stylus types can be actuating using a variety of different electrical and wind-up means. Vibrational generation means can include but are not limited to: solenoid actuation, piezo-electric, field coil drive, off-set rotational axis spinning, various engraving means, and the like. By way of example, hand held engravers, toy engravers, and related vibrating means can be used to stimulate or induce a color change in an intrinsic color change substrate.

Hand actuated frictional Stylus Systems:

Hand actuated frictional stylus types can be comprised with: wood, plastics, stiff paper sticks, composites, ceramics, coated metals, painted metals and plastics, thermal plastics, high impact plastics, rubbers and rubberized compositions, polymer composites, carbon fiber rods, glass, plastic rods, powder coated metal rods, anodized aluminum rods, graphite rods, rods made with natural or synthetic composites, and the like. The composition of a rod of interest will be determined by the application of interest, ease of use, functionality, cost, and related specifications. Rod compositions can be utilized directly on a color change substrate or utilized indirectly as a handle of implement.

Rod types can be extruded, machined, injection molded, milled planed, drawn from a melt, cast, thermoformed, die-cut, compression molded, sliced, cut, or made by any of a variety of convenient commercial means. Method for making and producing a frictional stylus will be determined by the application of interest, ease of use, functionality, cost, and related specifications.

### Resistive Heating Stylus Systems:

Heating elements can be prepared using a variety of means including resistance heating wire such as nichrome wire, conductive inks, silver inks, thermal poly-switches, positive temperature coefficient (PTC) materials, carbon resistance inks, platinum wire, resistive metal plates, metal slugs, and the like. Resistive heating elements can be designed with a wide range of different geometric shapes including wedge shapes, points, loops, flat bars, twists, multiple protrusions, zig-zag shaped, and the like. An element geometry can be designed for a particular product type of interest.

Resistive heating stylus types can utilize temperature feedback control mechanisms, resistance limited heating levels, temperature dissipation control mechanisms, power limited heating control mechanisms, or the like. Integrated temperature monitoring devices provide an intimate feedback circuit such that on/off cycling can be achieve with a high level of precision.

Resistive heating elements can be designed to operate within the specified temperature range of a particular substrate of interest. Typically element temperatures will range from −50° C. to over 250° C. Usually convenient temperatures for functional stylus types will range from 0° C. to 200° C. More usually and often, temperatures utilized will range from 10° C. to 150° C. Most often, temperature ranges of interest will range from between 20° C. to 100° C. The exact temperature will be based on available and amenable dye systems, the application of interest, convenience of production, printing methods, stylus types utilized, and the like.

### Hot Gas/Air Stream Stylus Systems:

Heat elements can be utilized in combination with forces or driven air streams to create miniaturized hot air streams. The hot air stream can be used as the thermal triggering mechanism in an intrinsic color change substrate. Non-direct contact serves as a major advantage of using an air stream. Likewise, hot air streams carry a low thermal mass an therefore have less potential for overheating or burning an undesired area.

### Hot Melt Glue Gun Stylus:

Transparent or semi-transparent hot melt glue guns and hot melt glue can be utilized as a convenient stylus type for stimulating a heat-triggered color change in an intrinsic color change substrate type. Of particular interest is the extrusion of a melted transparent hot melt glue onto an intrinsic substrate. The color change occurs immediately beneath the extruded hot melt composition and emanates outward to a distance at which thermal transfer between the hot melt composition and the color change dye ceases to have a high enough temperature to trigger a color change event. Semi-transparent hot melt compositions have the added benefit of creating a transparent “lens” effect through which the color change event can be seen. The optical effect provides a pleasing three-dimensional appearance to the intrinsic color change artwork.

### Optical Heating Element Systems:

Optical heating elements can include heat generating light sources that cause a color change in a substrate type. Heating bulbs can be incandescent, a heating light emitting diode, miniaturized solid-state lasers, or the like. Optical energy can concentrate and focused by conventional means including mirrored reflectors and lenses.

An advantage of optical heating element systems is that direct physical contact between the stylus heating element and the substrate can be avoided. For example, the optical energy can be focused from a point source at a specified distance away from a color change substrate such that the stylus can induce a color change in the medium at a distance away from the substrate.

Optical heating elements can also be utilized in direct contact with a substrate where an incandescent bulb that heats during use can be used as a direct heating stylus tip. Direct optical heating elements have the example of creating an optical shine on the area of color change substrate that undergoes a triggering event. Small or large bulbs can be utilized. Of interest are small halogen bulbs that can serve as satisfactory heating sources.

### Miniature Ultra-Sonic Probe Stylus Types:

Minimal contact stylus techniques can produce color generation effects in intrinsic color change substrates. Ultra-sonic wave fronts generated by a ultra-sonic probes can be used as physical means for inducing a color change in an intrinsic dye-layer substrate. High-energy Ultrasound probes have the advantage that the probe itself may require little or no contact with the substrate during usage. Ultrasound probes can be sufficiently small to use as a fine drawing tip, and any rigid portion must be limited in length to permit adequate flexibility. Small probe tips must operate at high frequencies. Both linear and cylindrical array configuration designs can be utilized in a final stylus tip type. Ultra-sonic stylus and tip probe types can be fabricated using methodologies and techniques utilized by those familiar to medical imaging and surgery industries.

### Chemical/Stylus Activation:

Pre-conditioning chemical agents for selective color development can be utilized on intrinsic color change substrates. Stylus delivery formats compatible with printing, drawing, arts, crafts, lettering, writing, coloring, painting, and any related activity can be utilized for initiating a pre-patterned color change in the intrinsic color change substrate. Chemically induced color change processes and stylus types can be used alone or in combination with a multi-functional or activating intrinsic substrate.

For encapsulated leuco dye systems that contain dye-forming chemistries, color development can be initiated using liquid composition that break down the capsule sidewalls. The breakdown process leads to dispersion and mixing of dye forming chemistries resulting a in color development. Dye forming systems can be encapsulated in one or more capsule composition. Liquids selected for capsule disruption will depend on the capsule composition utilized in producing the encapsulated dye. Capsules can be decomposed using aqueous or organic compositions.

The breakdown composition can be present at from 0.01% to 100% solution. More usually, the breakdown component will be present from 0.1% to 50% by weight solution. Typically, the breakdown component will be present from 0.5% to 10% by weight. The breakdown component can be admixed, mixed, dispersed, or dissolved in a carrier liquid. The carrier liquid can be aqueous or organic.

Typically, it is desirable to utilize carrier liquids that do not interfere with the breakdown process. Carrier liquids can be viscous or non-viscous depending on the application of interest. Carrier liquids can be utilized in a viscosity range from 0.5 centipoise to over 100,000 centipoise and in paste forms. More usually, the carrier liquid viscosity will range from 1.0 centipoise to 50,000 centipoise. Typically, convenient viscosities will range from 2.0 to 1,000 centipoise for most applications.

Alternatively, a breakdown composition can be utilized in a highly viscous or solid form. In such cases, the breakdown composition can be in a solid or semi-solid state. Solid or semi-solid breakdown components have the property of utilizing diffusion delay to generate or stimulate a color change in a color change chemistry when applied to an intrinsic color change substrate. The delay can be temperature dependent or temperature independent depending on interest in utilizing a time/temperature, time only or temperature only process for color development. Delayed type color change mechanisms can be made time and/or temperature dependent. Time and/or temperature dependent color change delays can be have the potential to be utilized in time and/or time/temperature sensing devices, indicators, or sensors.

A wide range of solvent based liquids, gels, grease pens, inks and ink compositions, sprays, markers, marking inks, pyrole compounds, short and long chain amines, combinations of amine/solvents, fatty solutions, oils, organic solvents, inorganic solvents, alcohols short to long chain, acetone, fatty acids, ethylene glycol, glycols, polyglycols, diacetone, ethers, polyethers, tetrahydaphenone, detergents, surfactants, pH based initiators, basic solutions, acidic solutions, low volatility solvents, high volatility solvents, acetic acid, polyethylene glycols, polypropylene glycols, grease reactive agents, parachlorobenzotrifluoride, dibutyl phthalate, dibutyl maleate, diethyl succinate, chlorinated fluorinated toluenes, perflorinated solvents, lipid emulsions, surfactants, surfactant mixtures, short to long chain alcohols, branched alcohols, hydrocarbon solvents, and the like can be utilized in chemical color change activation systems. Commercially available color activation solvents, solutions, emulsifications can be utilized as chemical activating color change agents. Members of leuco dye color change agents can be dissolved in organic solvents or aqueous emulsions as color change chemical agents.

Acidified or basic compositions can be employed whereby an aqueous solution or emulsion containing an oil and/or an organic solvent and/or a strong acid or base can be utilized as an encapsulation disruptor composition that can be used to induce a color change in the intrinsic substrate.

Liquified fluorescent dye compositions can be utilized in combination with chemically inducing color change agents such that a pre-color fluorescent pen composition can be used to make a fluorescent mark that in turn induces a color change in the substrate whereby the color change is from white to fluorescent to a combination of the fluorescence along with the intrinsic color change type that is intrinsic to the substrate color change.

Chemical stylus can be a drop-on-demand delivery format where the activating chemical can be jetted from an actuation nozzle in an analog or digital pattern and/or sequence to create a wide range of different coloration effects on the intrinsic color change substrate. Likewise, continuous inkjet or other inkjet formats can be utilized in convenient configurations to deliver solutions containing breakdown components.

Stylus types can include, but are not limited to pencil types, pen types, applicator bottles, application sponges, brushes, non-contact spray or inkjet nozzles, tubes, droppers, eye droppers, retractable pens, straws, prayers, spray bottles, spritzing methods, finger painting, or any other convenient delivery or application means that delivers a quantity of breakdown composition to the surface of an intrinsic color change substrate for a desired color change effect.

Importantly, the intrinsic color change substrate compositions disclosed here within, have the enabling and unique property of being activated to a color change induced state by one or more different physical, optical, or chemical activation means and/or stylus type. The multi-functional color change properties of the intrinsic substrate compositions described herein provide for wide reaching product applications where one or more color change stimuli can be employed within the same product type.

### Interchangeable Tips and Kit Elements:

Of particular interest and convenience are removable tips and/or interchangeable tips on the end of a stylus. Tip types can be removed, interchanged, replaced using a convenient attachment mechanism including: jacks, chucks, sockets, reverse threads, snap-in sockets, adaptors, pressure connectors, or the like. Interchangeable or replaceable tips can be used to assemble a kit set for a complete drawing or artist's experience. Tip types can be selected for a particular kit user level. For example starter kits can be assembled using selected intrinsic color change substrate sheets, a simple to use stylus, and 3 interchangeable tip types. The tip types can include a pointed end tip, a blunt end tip and a disc shaped tip. Various product offerings can be developed for age groups, experience levels, themes, art or craft type, or the like. By way of example, an artist's kit can include tips that can be used to generate brush strokes, fine lines, various line widths, frosting effects and the like.

### Power Sources for Electric Stylus Types:

Electric stylus types can be powered by battery or a using an alternate current adaptor. Battery types will typically include low cost and conveniently sized cells including A AA, AAA, AAAA, C, and D cells. Alternatively, 9 volt and smaller stacked disc cells may be utilized. Power adaptors including 110 volt and 220 volt wall adaptors may be of use. AC or DC power systems can be utilized. Voltages and amperage ratings will depend on the stylus type and power requirements. Usually voltages utilized will range from 1 volt to over 50 volts. More usually, voltages will range from 1.5 volts to 25 volts. Most often, voltages utilized will range between 3 and 9 volts.

### Stylus Control Mechanisms:

Stylus types can be designed and made for increased control by young or less able age groups. Control can be accomplished by designing the stylus handling mechanism for easy holding. Sleek or thin designs can be used whereby batteries or other elements can be in a linear shape. Thin diameter batteries such as AA, AAA, and AAAA can be utilized in linear end-to-end configurations to create thin or narrow shapes. Accessories or straps can be used for improving hand-holding by small hands or fingers.

Gyro mechanisms can be employed to steady the tip and/or stylus body in a desired position. Finger grips, grip mechanisms, soft grips, gel-filled grips, compliant grips, rubber grips, contoured grips, finger shaped grips, elastic grips, self-molding section, semi-adhesive grips, and the like can be utilized for improved holding performance. High-speed rotational effects of a tip can be used as a gyroscopic control mechanism for tip/stylus control. The rotating tip can simultaneously act to trigger a color change in a substrate an facilitate handling though vector forces generated by axial high-speed rotation.

As an alternative to movement by hand a stylus type can be further functional by attaching it to an actuating means. The actuating means can be mechanical, further motor driven, spring loaded, pendulum actuated, moved by a gear mechanism, moved by a toy vehicle motion, moved with a linear x, xy, or xyz motion mechanism, traversed using a pulley mechanism, moved by a printer mechanism, moved using an Etch-A-Sketch™ motion system, or other motor driven, levered, or motion control system. By way of example, a stylus type can be attached to a small radio controlled robotic toy such that the stylus can be traversed over an intrinsic color change substrate in a play-like or controlled fashion. Alternatively, a stylus type can be attached to a mechanical drawing plotter where the tip can be moved using a hand controlled means.

### Stylus Peripheral Elements:

Stylus peripheral elements can include, but are not limited to displays, lights, audio or visual signaling elements, readouts, other alerting mechanisms, feedback mechanisms, sensors, indicators, inductors, inducers, or the like that facilitate and/or communicate to the user interaction between the substrate and the stylus, the stylus and the user, or the user and the substrate information during the encoding or recording process. By way of example, information can be encoded in a printed substrate that can be sensed by the stylus such that the stylus can respond by altering its function. Encoded markers in the substrate can be sensed by the stylus such that the stylus changes a parameter such as rotational speed, heat, or vibrational frequency. In another example, LED lights can rotate with rotational tips to create interesting visual outputs form the stylus and color change substrate simultaneously. Further, sensors in the end of a stylus tip can be used to sense and feed back to the stylus what color has been triggered such that the stylus can respond by changing a characteristic of the stylus mechanism such as speed, frequency, on/off or the like.

Conductive, optical, marking, or other features can be incorporated into the substrate that can be sensed by and responded to through a parameter change in the function of the stylus. Temperature of a stylus heating element for example can be elevated or lowered resulting in a differential color change in a dye system embedded or layered in the substrate.

### Thermochromic and Color Change Colorant Additives for Substrates:

The substrate/stylus color change recording system can utilize a variety of dye systems that are determined by the product application of interest. Encapsulated dyes, polydiacetylenes, leuco dyes, solvent chemically initiated color change systems, frictionally sensitive dyes, separated dye layers, partition dyes, electron transfer dyes, two-component chemical dyes, organic and inorganic color change dye systems, acid/base dye systems, melting waxes, sublimation dyes and the like can be utilized. One or more dye-layers of a given dye system can be utilized alone or in combination with alternative dye systems.

Thermochromic dyes can find use in a variety of compositions and applications and formats. Thermochromic dyes can include but are not limited to compounds including: bis(2-amino-4-oxo-6-methylpyrimidinium)-tetrachlorocuprate(II); bis(2-amino-4-chloro-6-methylpyrimidinium)hexachlorod-icuprate(II); cobalt chloride; 3,5-dinitro salicylic acid; leuco dyes; spiropyrenes, bis(2-amino-4-oxo-6-methylpyrimidinium) tetrachlorocuprate(II) and bis(2-amino-4-chloro-6-methylpyrimidinium) hexachlorodicuprate(II), benzo- and naphthopyrans (Chromenes), poly(xylylviologen dibromide, di-beta-naphthospiropyran, Ferrocene-modified bis(spiropyridopyran), isomers of 1-isopropylidene-2-[1-(2-methyl-5-phenyl-3-thienyl)ethylidene]-succinic anhydride and the Photoproduct 7,7adihydro-4,7,7,7a-tetramethyl-2-phenylbenzo[b]thiophene-5,6-dicarboxylic anhydride, and the like.

Other thermochromic dyes of interest include leucodyes including color to colorless and color to color forumations, vinylphenylmethane-leucocyanides and derivatives, fluoran dyes and derivatives, thermochromic pigments, micro and nano-pigments, molybdenum compounds, doped or undoped vanadium dioxide, indolinospirochromenes, melting waxes, encapsulated dyes, liquid crystalline materials, cholesteric liquid crystalline materials, spiropyrans, polybithiophenes, bipyridine materials, microencapsulated, mercury chloride dyes, tin complexes, combination thermochromic/photochromic materials, heat formable materials which change structure based on temperature, natural thermochromic materials such as pigments in beans, various thermochromic inks sold by Securink Corp. (Springfield, Va.), Matusui Corp., Liquid Crystal Research Crop., or any acceptable thermochromic materials with the capacity to report a temperature change or can be photo-stimulated and the like. The chromic change agent selected will depend on a number of factors including cost, material loading, color change desired, levels or color hue change, reversibility or irreversibility, stability, and the like.

Of particular interest are irreversible leuco dye compositions that involve encapsulated dyes/activators. Dye systems can include the activation component encapsulated in one species of micro-particles and an uncolored dye encapsulated in a second species of micro-particulate. No color occurs when the two components are mixed until the encapsulation of both micro-particulates are simultaneously ruptured and the un-activated dye can be activated by the released activator. Dye system sources can be obtained from various vendors for formulating intrinsic color change substrates. Selected vendors include: Thermographic Measurements Ltd. (TMC, United Kingdom), NuCoat, Inc. (North Plymouth, Minn.), Appleton Papers Inc. (Appleton, Wis.) as well as other custom suppliers and processors.

Certain dyes specified as thermochromic dyes by vendors or manufacturers can be converted to frictionally responsive or sensitive dye layer systems. For example, irreversible thermochromic ink formulations can be coated on substrates and triggered using frictional or compression means for initiating a color change. Color change systems that have multiple elements including a printed substrate, a stylus, and a stylus tip can be assembled and produced as a system for product sales.

Of further interest are pressure indicating pigments and films that respond locally and specifically to an applied pressure by changing color in response to the applied pressure. Pressure indicating films can include, but are not limited to carbon papers, Pressurex™ films, pressure indicating dyes, encapsulated pressure indicating dyes and the like. Likewise, direct thermal printing papers and films can be used as a commercially available source for color change substrates. Thermal papers are available in various colors including white to black, white to blue, and white to red. Direct thermal papers can be over coated or printed so that the initial white color can be a color other than white and the color transition can be color to color. Importantly, thermal papers can be further treated in additional intrinsic color change dye layers to create multicolor change substrates. Additional intrinsic color change dyes can have temperature triggering set points at levels different than the thermal paper thereby creating a color change substrate that can turn different colors at different temperatures or different stylus force exertions.

Alternative thermochromic materials can be utilized including, but not limited to: light-induced metastable state in a thermochromic copper (II) complex Chem. Commun., 2002, (15), 1578-1579 under goes a color change from red to purple for a thermochromic complex, [Cu(dieten)2](BF4)2 (dieten=N,N-diethylethylenediamine); encapsulated pigmented materials from Omega Engineering Inc.; bis(2-amino-4-oxo-6-methyl-pyrimidinium)-tetrachlorocuprate(II); bis(2-amino-4-chloro-6-methylpyrimidinium)hexachlorod-icuprate(II); cobalt chloride; 3,5-dinitro salicylic acid; leuco dyes; spiropyrenes, bis(2-amino-4-oxo-6-methylpyrimidinium)-tetrachlorocuprate(II); bis(2-amino-4-chloro-6-methylpyrimidinium) hexachlorod-icuprate(II); cobalt chloride; 3,5-dinitro salicylic acid; leuco dyes; spiropyrenes, bis(2-amino-4-oxo-6-methylpyrimidinium) tetrachlorocuprate(II) and bis(2-amino-4-chloro-6-methylpyrimidinium) hexachlorodicuprate(II), benzo- and naphthopyrans (Chromenes), poly(xylylviologen dibromide, di-beta-naphthospiropyran, Ferrocene-modified bis(spiropyridopyran), isomers of 1-isopropylidene-2-[1-(2-methyl-5-phenyl-3-thienyl)ethylidene]-succinic anhydride and the Photoproduct 7,7adihydro-4,7,7,7a-tetramethyl-2-phenylbenzo[b]thiophene-5,6-dicarboxylic anhydride, and the like. Encapsulated leuco dyes are of interest since they can be easily processed in a variety of formats into a plastic or putty matrix. Liquid crystal materials can be conveniently applied as paints or inks to surfaces of color/shape/memory composites.

Polydiacetylenic dyes are of particular interest for thermochromic dye mediums due to their high extinction coefficient, reversible or irreversible color change characteristics, ease of coating and printing, ease of modification for temperature setting adjustment, low level of migration on a printed substrate, large dynamic color change range, their characteristics of being able to be printed at high resolution, compatibility to be used in combination with other thermochromic dyes, ease of formulation into a range of different ink resin matrices, potential for low levels of toxicity due to their large molecular weight, and facile nature for undergoing color change transitions utilizing a variety of different triggering mechanisms.

Thermochromic color to colorless options can include by way of example, but not by limitation: yellow to colorless, orange to color less, red to colorless, pink to colorless, magenta to colorless, purple to colorless, blue to colorless, turquoise to colorless, green to colorless, brown to colorless, black to colorless. Color to color options include but are not limited to: orange to yellow, orange to pink, orange to very light green, orange to peach; red to yellow, red to orange, red to pink, red to light green, red to peach; magenta to yellow, magenta to orange, magenta to pink, magenta to light green, magenta to light blue; purple to red, purple to pink, purple to blue; blue to pink; blue to light green, dark blue to light yellow, dark blue to light green, dark blue to light blue; turquoise to light green, turquoise to light blue, turquoise to light yellow, turquoise to light peach, turquoise to light pink; green to yellow, dark green to orange, dark green to light green, dark green to light pink; brown and black to a variety of assorted colors, and the like. Colors can be deeply enriched using fluorescent and glow-in-the-dark or photo-luminescent pigments as well as related color additives.

Reversible and irreversible versions of the color change agent can be employed depending on the desired embodiment of interest. Reversible agents can be employed where it is desirable to have a multi-use effect or reuse the color change effect. For example, products with continued and repeated use value will find utility of a reversible color change component comprising the final embodiment. In this case it would be desirable to utilize a reversible thermochromic or luminescent material which can be repeated during usage. In another example, it may be desirable to record a single color change permanently. In this case, it would be desirable to utilize a thermochromically irreversible material which changes from one color to another giving rise to a permanent change and indicating that the composition should be discarded after use.

Thermochromic dyes can be added in to ink, printing or coating from 0.001% by weight to 80% by weight. More usually, the dye additive will find use in the range form 0.01% to 50% by weight. Usually, the additive will range in concentrations from 0.1% to 25%. Typically and most often, the colorant will be added in a range from 0.5% to 5%.

Additional optical dyes can be added in combination with thermochromic dyes to create plural optical effects. Photochromic and photoluminescent dyes can be added in various rations and combinations. Photochromic dyes can find use in a variety of color change mediums and formats. Photochromic materials can include but are not limited to dyes including: 1,3-Dihydro-1,3,3-trimethylspiro[2H-indole-2,3′-[3H]phenanthr[9,10-b](1,4)oxazine]; bicyclo[2.2.1]hepta-2,5-diene; benzyl viologen dichloride; 4,4′-bipyridyl; 6-bromo-1′,3′-dihydro-1′,3′,3′-trimethyl-8-nitrospiro[2H; 5-chloro-1,3-dihydro-1,3,3-trimethylspiro[2H-indole-2,3′-(3H)naphth[2,1-b](1,4)oxazine]; 6,8-dibromo-1′,3′-dihydro-1′3′,3′-trimethylspiro[2H; 1,1′-diheptyl-4,4′-bipyridinium dibromide; 1′,3′-dihydro-5′-methoxy-1′,3′,3′; 1′,3′-dihydro-8-methoxy-1′,3′3′-trimethyl-6-nitrospiro[2H]; 1′,3′-dihydro-1′3′,3′-trimethyl-6-nitrospiro[2H-1-benzopyran-2,2′-(2H)-indole]; 1,3-dihydro-1,3,3-trimethylspiro[2H-Indole-2,3′-[3H]naphth[2,1-b][1,4]oxazine]; 1,1′-dimethyl-4,4′-bipyridinium dichloride; 5-chloro-1,3-Dihydro-1,3,3-trimethylspiro[2H-indole-2,3′-(3H)phenanthr[9,10-b](1,4)oxazine]; 5-methoxy-1,3,3-trimethylspiro[indoline-2,3′-[3H]naphtho[2,1-b]pyran]; 2,3,3-trimethyl-1-propyl-3H-indolium iodide, and the like.

Of interest are a large range of different micro-crystalline diacetylene compounds that possess a photochemical color change polymerization reaction under exposure to 254 nanometer ultraviolet light, gamma irradiation, cobalt 60 sources, thermal polymerization and other high energy sources such a sun light.

### Color Change Temperature Ranges:

Thermochromic color change transitions for reversible or irreversible dye systems can be adjusted for a given product applications of interest. Typically thermal transitioning temperatures will range from −50° C. to over 250° C. Usually convenient temperatures for functional stylus types will range from 0° C. to 200° C. More usually and often, temperatures utilized will range from 10° C. to 150° C. Most often, temperature ranges of interest will range from between 20° C. to 100° C. The exact temperature transition will be based on available and amenable dye systems, the application of interest, convenience of production, printing methods, stylus types utilized, and the like.

### Photochromic and Photoluminescent Dye Systems:

Photo-luminescent compounds can find use in a variety of color change mediums and formats. Photo-luminescent compounds can include, but are not limited to, a variety of materials. Greens, green blue and violet can be made with alkaline earth aluminates activated by rare earth ions. By way of example, strontium aluminate can be activated using europium (SrAl0₃:Eu). Visual wavelengths can include: green at 520 nm, blue-green at 505 nm, and blue at 490 nm. Red and orange colors can be generated with zinc sulfide.

Photochromic and photoluminescent dyes can be added in from 0.001% by weight to 80% by weight. More usually, the dye additive will find use in the range form 0.01% to 50% by weight. Usually, the additive will range in concentrations from 0.1% to 25%. Typically and most often, the colorant will be added in a range from 0.5% to 5%.

A wide range of additional colorants and pigments can be added to supplement or enhance the intrinsic color change effect Pigments can include, but are not limited to: micas, pearlescent particles, glitters of assorted colors, glass flake powders, metallic flake pigments, luster pigments, fluorescent dyes, whitening agents, darkening agents such as carbon black, and the like. Additional colorant pigments and colorants can be added to a coating color change ink matrix or post-coated on a pre-printed color printed layer. Colorants and pigments can be added dyes can be added in from 0.001% by weight to 80% by weight. More usually, the dye additive will find use in the range form 0.01% to 50% by weight. Usually, the additive will range in concentrations from 0.1% to 25%. Typically and most often, the colorant will be added in a range from 0.5% to 5%.

### Substrate Medium Types:

Substrates for printing intrinsic color change compositions can include, but are not limited to: various papers, film and foil types including normal photocopy paper, drawing paper, fluorescent papers, coated papers, cardboard, ink jet printing paper, sand paper for added internal abrasiveness, textured papers, ink jet printing papers, ink jet photo quality papers, matted or glossy finished papers, chip board types, water color papers, charcoal papers, bonded papers, coated and uncoated card stock, various weighted papers, satin finished papers, tracing papers, card stock, aluminum or other metal foils, plastic films and sheets, pressure sensitive adhesive papers and labels, and the like.

Substrates can be plain, colored, per-patterned, graphically image, photographically imaged, lettered, security coded, pre-printed, have pre-formed or drawn line art, or be any of a variety of printed media information. Substrates containing printed, imaged, or any information can be over coated with a color change dye composition for subsequent color manipulation with an intended stylus. Images, photographs, cartoons, artwork, licensed characters, insignias, logos, labels, advertising information or the like can be image through or in combination with a color change dye composition,

Holographic mediums can be over-printed using a color change composition whereby the color change reaction can lead to a change in the holographic effect in the medium as a result of the color change. Partially transparent holographic films can be layered over the top of a color change dye for superimposing the holograph over a color change or an enriched holographic film can be over-coated with a semi-transparent color change medium such that the hologram is visible beneath the dye layer. In either case, a holographic effect can be superimposed with a color change substrate during the stylus stimulated color change process.

Substrate mediums can be comprised with formulations, characteristics, chemical compositions, physical features, and/or agents that can assist in modulating the activity of a color change dye system to be triggered by a stylus tip. For example, smoother more slippery substrates coated with a color change medium can assist in the glide characteristics of a stylus moving over printed dye layer. Alternatively, a course substrate impregnated with an abrasive compound can assist in amplifying frictionally generated heat caused by a stylus tip moving in contact with a color change dye system whereby less pressure is required for inducing the color change effect. In other cases, the substrate may have periodically embedded electrical heating element conductors where an electric charge placed in contact the an embedded conductor can result in finite localized heating in the proximity of the conducting element leading to a color change in a dye system with in the heating radius of the heated conductor.

Likewise, conductive or insulating meshes can be laminated to a substrate whereby the mesh can endow the substrate with a particular property of revealing an image or producing an unexpected optical change. Laminating layers, impregnating layers, substrate fibers, substrate coating layers and the like can be used as means for augmenting a substrate to impart or impact the color change process.

### Substrate Dye Composition Coating Methods and Configurations:

Coating methods for applying an intrinsic color change dye system or layer to a suitable substrate include, but are not limited to ink jet printing, flexo-graphic printing, rotogravure printing, impact printing, transfer printing, screen printing, large area format printing, photographic printing methods that can be utilized, dye sublimation printing, spray printing, draw-down application, roller printing, flood coating, in-line printing, off-set printing and the like. The printing method of interest will be dictated by the dye-system utilized, product formatting, cost, printing volumes, speed, and convenience.

Substrates can be coated with ink bases containing a color change component or dye system where the dye system including a dye and developer are independently encapsulated and suspended in the ink base. Alternatively, dyes and developers can be independently applied to a substrate such that each encapsulated component are in close proximity of each other after the ink base has dried or cured.

Of further interest are coating methods where first and un-activated and un-encapsulated dye is applied to a substrate. After drying or affixing, a separation layer is used to coat and seal the un-activated dye layer. Subsequently, a developer can be applied in a thin layer on the upper facing surface of the separation layer. The developing layer may be further sealed with a final inert and protective over coating layer. Unlike common leuco-dye systems, a layering approach provides a convenient means for directly printing and preparing a dye activation substrate without having to first prepare bulk dyes through encapsulation.

Sensitivity settings for developing a particular color can be pre-determined such that higher or lower power outputs from a stylus can be used to generate a particular color of interest. By way of example, red, blue, green, orange, magenta, cyan, turquoise, purple, black or other colors can be encapsulated and prepared for turning color at a particular temperature or activation condition. Stylus settings can be pre-determined for a particular power output or stimulus output that is intended to trigger a color change for a given color type. For example three color types can be included in a dye system formulation on a substrate. Each color type may be selectively formulated to change color under with a given temperature, pressure, or frictional force applied by a stylus. Accordingly, a stylus can have pre-set operational modes that can be selectively turned off or on to match the stimulus characteristics of a dye. A first setting will stimulate a color change in a first dye. A second setting can be used for stimulating a color change in a second dye. Finally, a third setting can be used to stimulate a color change in the third dye. The number of dye colors and settings utilized will depend on the product application of interest.

### Visual Out-Puts for Intrinsic Color Change Substrates:

Printed patterns, graphics, images, symbols, text, pictures, reading materials, visual materials, visual aids, and the like can be printed in part or whole using an intrinsic color change dye system. Characters, visuals or and art or printed matter can be made to appear during the intrinsic color change process. By way of example, graphics printed with an intrinsic color change dye can be obscurely rendered on a substrate such that the image is invisible or non-apparent. The graphic can be lightly coated on a substrate such that the image cannot be discerned. Upon activation with a stylus, the image will appear in high contrast compared to the background.

### Visual/Machine Readable Multi-Color Outputs:

Intrinsic irreversible color change inks or coating solutions can include, but are not limited to red, blue, green (RGB), and cyan, magenta, yellow, and key—black (CYMK). The intrinsic color change printed composition can be utilized as printed spot mediums that can be spatially converted to form full color images using a compatible thermal printer.

Coatings can be accomplished on any pre-colored substrate. Pre-colored substrates can include, but are not limited to any RBG, CMYK, Pantone™, PMS or other color hue more match. Pre-colored substrates can include a wide range of other optical pigments including fluorescent dyes such as magenta, pink, yellow, blue, green, red, orange, and any of a variety of other colors, hues, or combinations.

Intrinsic irreversible thermal print coatings or dye solutions can be pre-colored with ancillary colorants such that the intrinsic ink solution is coated in a pre-colored form on any plain substrate. A wide range of dye compositions can be added or admixed into the intrinsic ink solution. Uniform dispersion of ink components can be accomplished by mixing, shear mixing, ultra-sonication, vortex mixing or the like.

Thermal print mediums can be fully formulated with an intrinsic irreversible dye composition to achieve a uniform color change over an entire substrate, or be selectively coated in specific regions of a substrate in order to achieve a localized color change effect. The localized color change effect can be triggered with an activating stylus and/or use of a thermal printer. Thermal printers find use as a means generating high resolution barcodes, images, logos, printed information, graphics, symbols, embedded images, photographic quality images, security encoded information, encrypted information or the like.

Of particular interest are intrinsic substrates that are printed at high resolution that can be utilized with high resolution thermal printers for generating high resolution full color images and printed matter. Various print arrays can be accomplished that comprise RGG and CMYK color matrices on an intrinsic substrate. Registration between pre-intrinsically printed substrate and a thermal printer can be accomplished using surface diffraction methods. Surface diffraction from a surface ordered substrate can be used to generate a readable diffraction pattern. The diffraction pattern can be measured by an internal CCD array in the printer to provide a real-time non-destructive means of prompting the printer as to the location of micro-printed RGB or CYMK intrinsic ink spots such that the print heads can be aligned in real-time to create an optimal high-resolution full color printout.

A wide range of different color change or adaptable barcodes can be printed on irreversible or reversible intrinsic color change substrates. Color change options are no longer limited to conventional color change thermal papers (white to black, white to blue, or white to red). Described here within are is wide range of additional color change options that can be flood coated or selectively printed on film paper or other compatible substrates. Irreversible color change options can now include, but are not limited to: white to magenta, white to cyan, white to orange, white to purple, white to green, white to pink, white to brown, white to yellow, white to turquoise, white to aqua, white to tan, white to deep red, white to deep blue, white to violet or the like. Pre-colored color change options can include, but are not limited to any RBD and/or CMYK combination, PMS color, Pantone™, color, fluorescent color including, but not limited to red to magenta, red to cyan, red to orange, red to turquoise, red to aqua, red to purple, red to green, red to brown, red to tan, red to deep blue, red to violet; magenta to red, magenta to cyan, magenta to orange, magenta to turquoise, magenta to aqua, magenta to purple, magenta to green, magenta to brown, magenta to tan, magenta to deep blue, magenta to violet; yellow to red, yellow to cyan, yellow to orange, yellow to turquoise, yellow to aqua, yellow to purple, yellow to green, yellow to brown, yellow to magenta, yellow to deep blue, yellow to violet; pink to cyan, pink to orange, pink to turquoise, pink to aqua, pink to purple, pink to green, pink to brown, pink to tan, pink to deep blue, pink to violet; green to red, green to cyan, green to orange, green to turquoise, green to purple, green to brown, green to tan, green to deep blue, green to violet, and any of a variety of other color change combinations that employ an irreversible, printable intrinsic color change composition.

Thermal printers can be utilized in a variety of means to encode thermal print information by utilizing irreversible intrinsic color change dyes. Barcodes can be made functional, partially functional, non-functional, to change characteristics, to change meaning, to change numerical value, used as a color change thermometer means, or the like. Localized or flooded regions of a substrate can be coated with an irreversible color change intrinsic dye using conventional printing means, flexographic printing, off-set printing, rotogravier printing, dye sublimation printing, inkjet printing, coating processes, drop-on-demand ink jet printing, continuous inkjet printing, spray coating or the like.

Flexographic intrinsic ink formulations or other printing formulations can be conveniently coated on to various label stock materials in selected locations such that an intrinsic color change process such and thermal printing can be accomplished to achieve a desired color change effect on a printed article, piece or label. The added intrinsic color change region selected location can be of further value to barcode labels in that their color change can be additive to the value placed on a readable barcode. By way of example and interest, but not limitation, a standard thermally printed barcode can be printed on standard direct thermal print paper. The paper can be pre-printed with a region of intrinsic irreversible color change composition. Whereas the direct thermal print paper or substrate may turn from a white to black, the intrinsic color change area may be activated to turn to a color other than black—such as red, green, blue, cyan, orange, purple or any other acceptable intrinsic color change.

Alternatively, printed matter, barcodes or other machine readable encoded information may be printed on standard coated or uncoated print or printed mediums. An additional print color comprising an intrinsic color change composition can be printed on the medium such that only intrinsically printed region will respond to a physical or chemical impact. The intrinsically activating region can be imparted on-demand separately from any adjacent standard printed region.

Intrinsic color change regions can be printed on any of a variety of standard and non-standard substrates, papers, films, label stock, role stock, on interactive substrates such as RFID devices both passive and active, on printed circuit boards, on integrated circuit modules, on product surfaces, on packaging, on consumable products, on commercial items, on dissolving paper substrates, on plastics, on metals, in food packaging for cooking and food storage, or the like. Of interest is printing a region of intrinsic color change irreversible ink on interactive labels such as RFID labels substrates. The use of on-demand thermal printing on articles incorporating RFID devices is becoming of increasing interest. Utilizing selectively printed irreversible intrinsic color change regions adjacent to, on top of, or in conjunction with a laminated RFID device provides for the advantage of overprinting and or localizing a thermal print zone on any pre-existing substrate. On-demand thermally printed barcodes produced from intrinsic color change ink regions provides for a localized means of integrating RFID encoded information into a machine readable barcode.

Selectively printing an intrinsic irreversible color change composition can have the advantages of significant cost savings in that the entire substrate does not need to respond to a thermal event or process; multiple independent color changes can be deployed on the same print medium so that different colors can be used for different purposes; over-printed intrinsic color change printed regions can be utilized in synergy with a stationary graphic or bar code such that the graphic or barcode can be changed selectively during a thermal print process; sensing elements or printed zones be added in order to provide the final printed article with interactive or indicating capabilities that the intrinsic print zone can respond to; the selectively printed intrinsic color change area can be used for advertising purposed whereby information can be encoded and revealed for promotional purposes; on-demand printing applications can be utilized where the selectively printed area can be modified using a thermal printer to include updated information such as date codes, date of use information, expiration information, restocking information, interactively updated information, or any of a variety of information that can be changed on-demand by a thermal printer or the like when necessary. Importantly, standard print media that includes areas intrinsic color change composition in combination provides for the high resolution, visual esthetics, mass printability, and diversity of printable paper and film stock with the significant added feature of an on-demand print feature that can be modified at will after the print article has been mass produced.

Enabling composition for thermal barcode printers for interrogation, change, modification, and confirmation of barcodes. Different color change combination can be used to evidence different events including, but not limited to temperature sensing barcodes, chemical sensing barcodes, tamper evident barcode elements, security element barcodes, feature elements for altering a barcodes intended function, identity elements, numerical alterations in a barcode, elements encoding logistics, elements encoding historical treatment of a product carrying a barcode sequence, elements reporting physical or chemical changes in the environment that a barcode undergoes alone or in association with an item intended to be recorded by the barcode, elements that record time duration through a color change an elemental part of a barcode, and by of example, physical changes such as external pressure changes that induce a color change in a barcode element.

Standard non-changing barcodes or machine-readable encoded information can be utilized in unison with an irreversible intrinsic color change composition. By way of example, standardized barcodes that have been printed with stationary non-changing inks can be interlaced, tangentially printed with, or printed adjacent to with an intrinsic irreversible color change composition such that the non-changing barcode can be adapted by an intrinsic color change in the adjacent color change component.

Different colors can be utilized to indicate different effects imposed in a barcode or barcode element. Discrete color changes can be formulated into different intrinsic color change inks such that a particular color change indicates a particular physical or chemical effect on the barcode.

Newly introduced and advanced barcode algorithms can further benefit from utilizing an intrinsic color change composition. By way of example, U.S. Pat. No. 6,070,805 describes methodologies utilizing a color transition whereby the colors are based on standard printing inks and colors. Utilizing intrinsic color change inks in combination with U.S. Pat. No. 6,070,805 provides for new enablements in the analysis, development, and utility of a wide range of barcode features.

### Commercial Characteristics:

Color change can be made irreversible or reversible.
Shelf-life for coated dried film compositions show >12 month stability at room temperature and ambient conditions prior to triggering.
Shelf-life for liquid/wet coating compositions show >12 months stability at room temperature.
Irreversible intrinsic color change is constant and stable >12 months after triggering.
The system is capable of generating a wide range of initial pre-triggered hues, saturations and intensities as well as corresponding post triggered hues, saturations, and intensities.
Safe and controlled triggering mechanisms can be utilized or employed.
The system is compatible with a wide range of coating and printing methods including, standard flood coating, inkjet printing, flexographic printing, spray coating, painting, and the like.
Dry film coatings can be applied between 5.0 microns and greater than 500 microns depending on printing methods and substrate type.
Strong color hues and contrasts can be generated with single coating processes.
Single color change compositions can be printed alone or in combination and patterns with a plethora of other color change elements. Printing resolutions can be processed at low to high resolution.
The system can be readily scaled for short run purposes or for high volume applications.
Colorations, hues, and contrasts can be readily adjusted using the appropriate stimuli (e.g. thermochromic, mechanochromic, chemochromic, or optionally photochromic) singularly or in combination post printing.

### Intrinsic Color Change Augmenting Agents:

Of particular interest are paper types that facilitate the color change process by providing a medium that accelerates or eases the color change process. For example, paper or film substrates coated with an intrinsic color change composition can be more or less abrasive. More abrasive substrates can assist in the color change process by aiding in fracturing an encapsulated dye that has been placed under pressure by a mechanical stylus mechanism.

A wide range of different abrasives can be employed to facilitate a color change transition on a substrate. The abrasive type and concentration can be adjusted to meet the requirements of a particular application or product type. Abrasives can include but are not limited to: pumice, silicon dioxide, fumed silicone, ground glass powder, ceramic powder, polishing powders used for metals or other surfaces, hard plastic powders, cellulose fiber types, inorganic salts, minerals, stone powders, and the like.

Substrates can be more or less thermally insulating. More thermally insulating substrate can assist in, the color change process by reducing the temperature and power requirements of a heating element-based stylus. More insulating substrates require less heat transfer from a heating element for inducing a color change that a thermally conductive substrate.

Substrates can be produced or treated with chemical augmenting compositions that can facilitate or assist in the color change induction process. For example, chemical additives can be applied to a substrate that facilitate wall breakdown of encapsulating dye compositions. Fats, non-volatile solvents, reactive acids or bases, salts, chemical intermediates, chemical activating agents, reducing agents, and the like can be added to a substrate matrix or be formulated as a part of a substrate that will be subsequently coated with an intrinsic color change dye.

Protective and/or Colorized Coatings:

Transparent laminate materials can be used to over-coat an intrinsic color change layer. The transparent material can be a film, tape, clear coat, ink clear coat, adhesive clear coat or any of a variety of protective coatings. Protective coatings can be sprayed on or applied by any convenient means. Protective coatings can be ultraviolet light activated and solidified. Transparent laminates can be used as protective coatings, layers to reduce smudging between adjacent colors, water proofing layers, solvent proofing layers, or the like. Likewise, semi-transparent laminating or coating layers can be colorized with a standard dye to provide an initial color of interest whereby the initial color will be changed to a second color that convolves the first initial standard color and the second color change color.

Protective colorized coatings can be faintly or deeply colored in order adjust, match or complement a color change being developed by a stylus. Transparent or semi-transparent films can be used to over coat or under coat a color change dye layer. Colorized coatings can be applied in film form, ink form, paint form, dye form or any convenient form that facilitate a particular optical effect of interest.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A system comprising:
an optical transitioning or color changing substrate; and
a mechanism for inducing the optical transition or color change in the substrate.

2. The system according to claim 1, wherein said mechanism is a stylus.

3. The system according to claim 2, wherein said stylus is a rotary stylus.

4. The system according to claim 3, wherein said rotary stylus comprises a pattern generator.

5. The system according to claim 2, wherein said stylus is a thermoelectric stylus.

6. The system according to claim 2, wherein said stylus is a vibration frictional stylus.

7. The system according to claim 2, wherein said stylus is a hand actuated frictional stylus.

8. The system according to claim 2, wherein said stylus is a heating stylus.

9. The system according to claim 2, wherein said system is a gas stream stylus.

10. The system according to claim 2, wherein said stylus comprises an optical heating element.

11. The system according to claim 2, wherein said stylus is an ultra-sonic stylus.

12. The system according to claim 2, wherein said stylus is a chemical color change induction stylus.

13. The system according to claim 2, wherein said stylus is a hot melt glue activating stylus.

14. The system according to claim 2, wherein said stylus comprises an attachment element that provides for tip interchangeability.

15. The system according to claim 1, wherein said substrate comprises a thermochromic dye.

16. The system according to claim 1, wherein said substrate comprises a frictionally responsive dye.

17. The system according to claim 1, wherein said substrate comprises a pressure responsive pigment.

18. The system according to claim 1, wherein said substrate comprises a combination of color change mechanisms.

19. The system according to claim 1, wherein said system is configured to product a parameter dependent color development profile.

20. (canceled)

21. A method comprising:
(a) providing a system comprising:
(i) an optical transitioning or color changing substrate; and
(ii) a mechanism for inducing an optical transition or color change in said substrate; and
(b) using said mechanism to induce an optical transition or color change in said substrate.

22-44. (canceled)
